(19) United States
(12) Patent Application Publication
(10) Pub. No.: US 2006/0106907 A1
(43) Pub. Date: May 18, 2006

(54) Method of analyzing correlations among four variables in two-dimension configuration and computer accessible medium

(76) Inventors: Sau-Ann Su, Hsinchu City (TW); Chia-Nan Hong, Hsinchu City (TW)

Correspondence Address: J C PATENTS, INC., 4 VENTURE, SUITE 250, IRVINE, CA, 92618, US

(21) Appl. No.: 10/992,028

(22) Filed: Nov. 17, 2004

(51) Int. Cl. G06F 17/15

(52) U.S. Cl. 708/424

(57) ABSTRACT

A method of analyzing a correlation among four variables in a two dimensions configuration and a computer accessible medium for storing a program thereof are provided. The method comprises providing a plurality of data comprising a first variable, a second variable, a third variable and a fourth variable. The first to the fourth variables have correlations. Then the data are marked in the two-dimension configuration according to the first and the second variables. The group correlation is marked according to the third variable. The character of the fourth variable is shown by a predetermined method in the two-dimension configuration according to the fourth variable.

### BACKGROUND OF THE INVENTION

1. Field of the Invention

The present invention relates to a method of analyzing correlations among variables, and more particularly, to a method of analyzing correlations among four variables in a two-dimension configuration and a computer accessible medium.

2. Description of the Related Art

Technology has been developing, and knowledge has also been expanding. How to absorb new information efficiently and rapidly has become a challenge to be dealt with. In the conventional two-dimension configuration, correlations between only two or three variables can be obtained.

After collecting the data, such as gate areas and channel currents, of complementary metal-oxide-semiconductor (CMOS) transistors, the channel current serves as the horizontal axis, i.e. X-axis, and the gate length serves as the vertical axis, i.e. the Y-axis, in the two-dimension configuration. If the third variable, such as the gate widths of the CMOS transistors, is going to be shown in the two-dimension configuration, the group relationship of the CMOS transistors with the same gate width is added with words or lines. In the conventional method, however, a fourth variable cannot be added, such as yields of the CMOS transistors, in the two-dimension configuration. As a result, the best yield of the CMOS transistor cannot be predicted after combining the data of the gate areas and channel currents.

### SUMMARY OF THE INVENTION

Accordingly, the present invention is directed to a method to analyze correlations among four variables in a two-dimension configuration so as to show the correlations among the four variables therein.

The present invention is also directed to a computer accessible medium for storing the program executing the method described above.

The present invention discloses a method of analyzing a relationship among four variables in a two-dimension configuration. The method comprises providing a plurality of data, each of which comprising a first, a second, a third and a fourth variables. The first, the second, the third and the fourth variables have correlations. Each of the data is marked in a two-dimension configuration according to the first, the second and the third variables thereof. A character of the fourth-variable of each of the data is shown in the two-dimension configuration by a predetermined method.

According to the method of analyzing the correlations among four variables in the two-dimension configuration of the present invention, the step of marking the first, the second and the third variables of each of the data in the two-dimension configuration comprises: determining locations of each of the data in the two-dimension configuration according to the first and the second variables, and marking group correlations of each of the data in the two-dimension configuration according to the third variable. The group correlation of each of the data can be marked by colors, words, geometric shapes, different sizes or graying hues. The step of showing the character of the fourth variable of each of the data comprises, for example, marking the character of the fourth variable by colors, words, geometric shapes, different sizes or graying hues which are different from those of the third variables.

The present invention also discloses a computer accessible medium for storing a program capable of executing a computer system. The program comprises the following instructions. First, a plurality of data are accessed, each of which comprises a first, a second, a third and a fourth variable, and the first, the second, the third and the fourth variables have correlations. Each of the data is marked in a two-dimension configuration according to the first, the second and the third variables thereof. A character of the fourth variable of each data is shown in the two-dimension configuration by a predetermined method.

In addition to marking each data in the two-dimension configuration according to the first and the second variables, and marking the group correlations of each data in the two-dimension configuration according to the third variable, in the present invention, the character of the fourth-variable character is also marked by colors, words, different sizes, geometric shapes or graying hues, in the two-dimension configuration. Accordingly, the correlations among the four variables can be shown in the two-dimension configuration.

The above and other features of the present invention will be better understood from the following detailed description of the embodiments of the invention that is provided in combination with the accompanying drawings.

### BRIEF DESCRIPTION OF THE DRAWINGS

FIG. 1 is a flowchart showing a method of analyzing correlations among four variables in a two-dimension configuration according to an embodiment of the present invention.

FIG. 2 is a configuration of a two-dimension configuration showing correlations among four variables according to the method in FIG. 1.

FIG. 3 is another configuration of a two-dimension configuration showing correlations among four variables according to the method described above.

### DESCRIPTION OF THE EMBODIMENTS

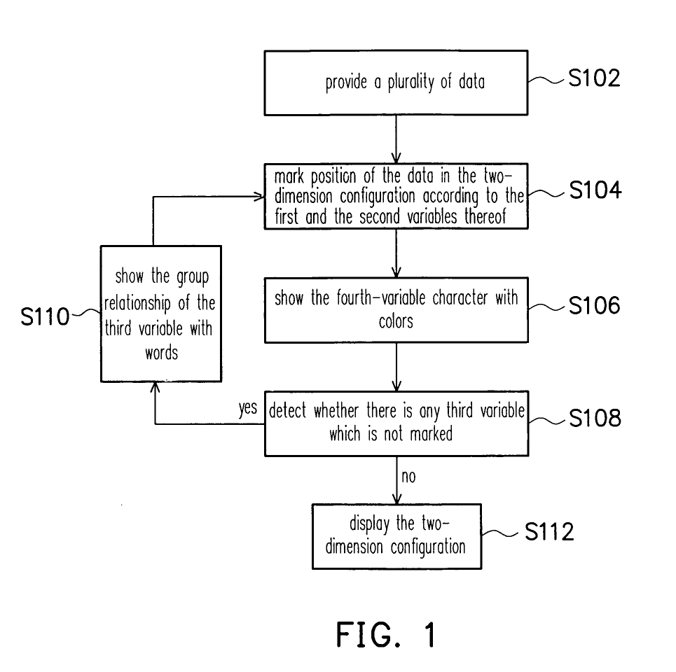

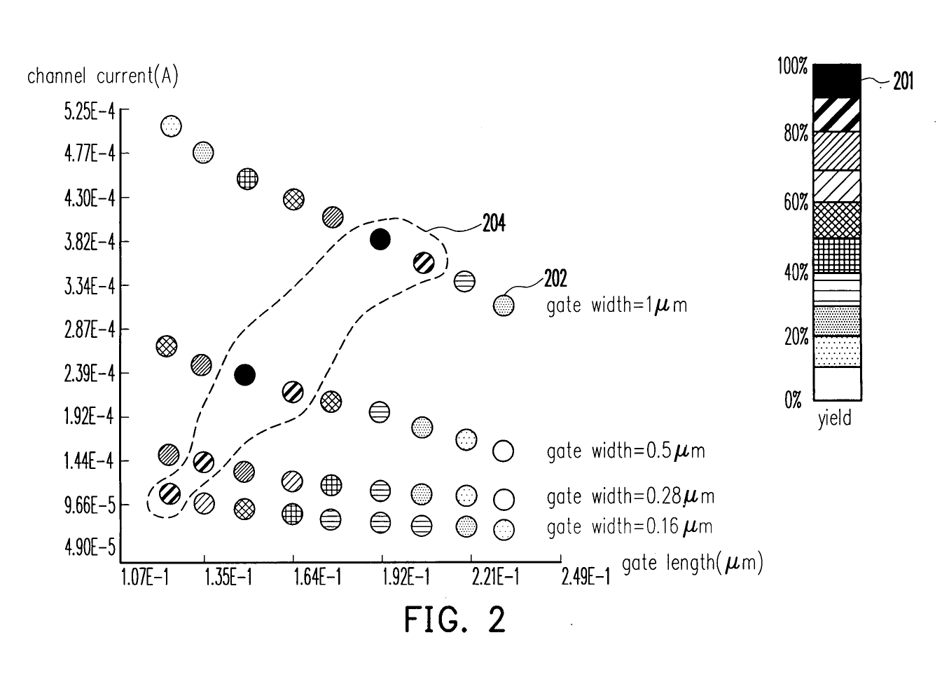

FIG. 1 is a flowchart showing a method of analyzing correlations among four variables in a two-dimension configuration according to an embodiment of the present invention. FIG. 2 is a configuration of a two-dimension configuration showing correlations among four variables according to the method in FIG. 1. Referring to FIGS. 1-2, in step S102, a plurality of data are provided. Each data comprises at least four variables, i.e. the first, the second, the third and the fourth variable. The four variables have correlations. In order to better describe the present invention, the data in this embodiment comprise specifications and characters in fabricating complementary metal-oxide-semiconductor (CMOS) transistors. The four variables can be, for example, the gate length and width, channel current and yield of the CMOS transistors. The present invention, however, is not limited thereto.

In step S104, the first variable and the second variable of the data with the same third variables serve as a horizontal axis, i.e. X-axis, and a vertical axis, i.e. Y-axis, respectively, in the two-dimension configuration. Accordingly these data are marked in the corresponding positions. For example, the vertical axis represents the channel current and the horizontal axis represents the gate length when the data of the CMOS transistor with 1-μm channel width are marked in the two-dimension configuration.

In step S106, the character of the fourth variable of each data is shown, for example, by colors, in the two-dimension configuration according to the fourth variable. For example, as shown in the color bar 201, different colors corresponds to different yields of the CMOS transistors. For example, the color of datum 202 shows that the yield of the CMOS transistor is between about 20% to about 30%. Due to black/white printing of FIG. 2, the character of the fourth variable is shown with different patterns. In some embodiments, the yields of the CMOS transistors can be shown by fading colors from the top to the bottom in the color bar 201. The character of the fourth variable may also be represented by words, geometric shapes, different sizes or graying hues. These modifications all fall within the scope of the invention.

In step S108, it is determined whether there is any unmarked third variable. If yes, step S110 is executed; if no, step S112 is performed. In step S110, the group correlations of the data are shown in the two-dimension configuration according to the third variables. For example, after steps S104 and S106 are finished, “gate width=1 μm” is marked to show the group correlations of the data. The third variable can be presented by words, geometric shapes, different sizes, colors or graying hues different from the way the fourth variable is presented. Any modification all falls in the scope of the present invention.

After step S110 is finished, the data corresponding to another third variable are marked in the two-dimension configuration by repeating the steps S104-S108 until the data of all third variables are marked in the two-dimension configuration. Then in step S112, the two-dimension configuration is displayed on the screen. For example, after marking the data of the “gate width=1 μm” group, the data of the CMOS transistor with the 0.5-μm gate width are marked in the two-dimension configuration by corresponding colors according to the steps S104-S110. Accordingly, the group correlations represented by “gate width=0.51 μm” is shown the two-dimension configuration. After all data of the CMOS transistors with different gate widths are marked in the two-dimension configuration, the two-dimension configuration is displayed on the screen.

In the two-dimension configuration, the correlations among the four variables is generated. Referring to FIG. 2, the horizontal axis represents the gate length, i.e. the first variable; the vertical axis represents the channel current, i.e. the second variable; the words describe the group correlations of the CMOS transistors with the same gate width, i.e. the third variable; and the patterns, or preferably fading colors, represent the yields of the CMOS transistors, i.e. the fourth variable. According to the two-dimension configuration, the best yield of the CMOS transistor can be predicted by combing the gate length and gate width so as to create the desired channel current. Referring to FIG. 2, for example, the area 204 has the best yield of the CMOS transistor.

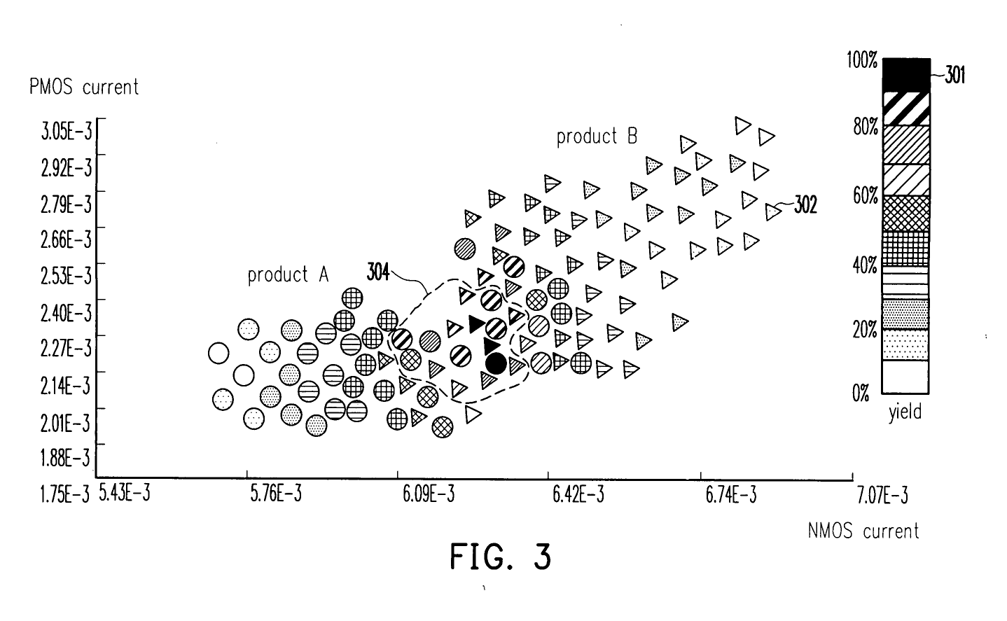

FIG. 3 is another configuration of a two-dimension configuration showing a relationship among four variables according to the method described above. The steps of creating the two-dimension configuration are described above. Detailed descriptions are not repeated. Referring to FIG. 3, with the method of the present invention, the correlations between CMOS transistors in different batch, currents of NMOS transistors, currents of PMOS transistors and yields can be analyzed.

In this embodiment, the horizontal axis represents the current of the NMOS transistors, i.e. the first variable; the vertical axis represents the current of the PMOS transistor, i.e. the second variable; words, such as “product A” and “product B”, cooperating with the geometric shapes, such as circle or triangle, of the data represent the group correlations of the CMOS transistors in different batches, i.e. the third variable; and the patterns, or preferably fading colors, represent the yields of the CMOS transistors, i.e. the fourth variable. For example, the different colors of the color bar 301 represent the yields of the CMOS transistors. The data 302 has about 10% to about 20% yield of the CMOS transistor.

According to the two-dimension configuration, the best yield of the CMOS transistor can be predicted by combing the current of the NMOS transistor, the current of the PMOS transistor and the CMOS transistor in different batches. Referring to FIG. 3, the area 304 has the best yield of the CMOS transistor.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A method of analyzing correlations among four variables in a two-dimension configuration, the method comprising:
providing a plurality of data, each of the data comprising a first, a second, a third and a fourth variables, and the first, the second, the third and the fourth variables having correlations;
marking each of the data in a two-dimension configuration according to the first, the second and the third variables thereof; and
showing a character of the fourth variable of each data in the two-dimension configuration by a predetermined method according to the fourth variable.

2. The method of claim 1, wherein the step of marking each of the data in the two-dimension configuration according to the first, the second and the third variables thereof comprises:
determining locations of each data in the two-dimension configuration according to the first and the second variables; and
marking a group correlation of each data in the two-dimension configuration according to the third variable.

3. The method of claim 2, wherein the step of marking the group correlation of each data in the two-dimension configuration according to the third variable comprises marking the group correlations of each data with graying hues.

4. The method of claim 2, wherein the step of marking the group correlation of each data in the two-dimension configuration according to the third variable comprises marking the group correlation of each data with colors.

5. The method of claim 2, wherein the step of marking the group correlation of each data in the two-dimension configuration according to the third variable comprises marking the group correlation of each data with geometric shapes.

6. The method of claim 2, wherein the step of marking the group correlation of each data in the two-dimension configuration according to the third variable comprises marking the group relationship of each of the data with different sizes.

7. The method of claim 2, wherein the step of marking the group correlation of each data in the two-dimension configuration according to the third variable comprises marking the group relationship of each of the data with words.

8. The method of claim 1, wherein the predetermined method comprises marking the character of the fourth variable of each data with colors.

9. The method of claim 1, wherein the predetermined method comprises marking the character of the fourth variable of each data with graying hues.

10. The method of claim 1, wherein the predetermined method comprises marking the character of the fourth variable of each data with words.

11. The method of claim 1, wherein the predetermined method comprises marking the character of the fourth variable of each data with geometric shapes.

12. The method of claim 1, wherein the predetermined method comprises marking the character of the fourth variable of each data with different sizes.

13. A computer accessible medium for storing a program capable of executing a computer system, the program comprising the following instructions:
accessing a plurality of data, each of the data comprising a first, a second, a third and a fourth variables, the first, the second, the third and the fourth variables having correlations;
marking each data in a two-dimension configuration according to the first, the second and the third variables thereof; and
showing a character of the fourth variable of each data in the two-dimension configuration by a predetermined method according to the fourth variable.

14. The computer accessible medium of claim 13, wherein the step of marking each of the data in the two-dimension configuration according to the first, the second and the third variables thereof comprises:
determining locations of each of the data in the two-dimension configuration according to the first and the second variables; and
marking a group correlation of each data in the two-dimension configuration according to the third variable.

15. The computer accessible medium of claim 14, wherein the step of marking the group correlation of each data in the two-dimension configuration according to the third variable comprises marking the group correlation of each data with words.

16. The computer accessible medium of claim 14, wherein the step of marking the group correlation of each data in the two-dimension configuration according to the third variable comprises marking the group correlation of each data with colors.

17. The computer accessible medium of claim 14, wherein the step of marking the group correlation of each data in the two-dimension configuration according to the third variable comprises marking the group correlation of each data with geometric shapes.

18. The computer accessible medium of claim 14, wherein the step of marking the group correlations of each data in the two-dimension configuration according to the third variable comprises marking the group correlation of each data with different sizes.

19. The computer accessible medium of claim 13, wherein the predetermined method comprises marking the character of the fourth variable of each data with colors.

20. The computer accessible medium of claim 13, wherein the predetermined method comprises marking the character of the fourth variable of each data with graying hues.

21. The computer accessible medium of claim 13, wherein the predetermined method comprises marking the character of the fourth variable of each data with words.

22. The computer accessible medium of claim 13, wherein the predetermined method comprises marking the character of the fourth variable of each data with geometric shapes.

23. The computer accessible medium of claim 13, wherein the predetermined method comprises marking the character of the fourth variable of each data with different sizes.
